(19) United States
(12) Patent Application Publication
(10) Pub. No.: US 2019/0308275 A1
(43) Pub. Date: Oct. 10, 2019

(54) METHOD AND DEVICE FOR PRODUCING A SHEET METAL BLANK BY MEANS OF LASER CUTTING

(71) Applicant: SCHULER AUTOMATION GMBH & CO. KG, Hessdorf (DE)

(72) Inventor: Alexander SEITZ, Erlangen (DE)

(21) Appl. No.: 15/757,025

(22) PCT Filed: Sep. 1, 2016
(86) PCT No.: PCT/EP2016/070651

§ 371 Date: Mar. 2, 2018

(30) Foreign Application Priority Data
Sep. 4, 2015 (DE) 10 2015 217 015.2

(51) Int. Cl. B23K 26/38; B23K 26/08; B23K 26/60; B23K 31/00; B21D 1/05; B21D 35/00

(52) U.S. Cl. CPC B23K 26/38; B23K 26/0838; B23K 26/60; B23K 2101/16; B21D 1/05; B21D 35/002; B23K 31/003

(57) ABSTRACT

The invention relates to a device for producing a sheet-metal blank by means of laser cutting, including a laser cutting device having a laser cutting head movable back and forth in a transport direction and in a y-direction extending vertically to the transport direction, and a stretching device for stretching a metal sheet accommodated in the laser cutting device. The device includes a first clamping device provided upstream of the laser cutting device for clampingly gripping a first portion of the metal sheet, a second clamping device provided downstream of the laser cutting device for clampingly gripping a second portion of the metal sheet, and a mechanism for changing a distance between the first and the second clamping device such that a tensile stress is exerted onto a metal sheet that is clampingly gripped therewith.

The invention relates to a method and a device for producing a sheet metal blank by means of laser cutting.

Document EP 0 707 905 A1 discloses a method for producing sheet-metal plates from sheet-metal blanks. A sheet-metal blank is conveyed to a stretching device by means of a transport device. The blank is then gripped and stretched in a stretching device. The sheet-metal blank is then fed to a cutting device.

Document WO 2010/052339 A1 discloses a device for producing a sheet-metal blank by means of laser cutting with a laser cutting device. The device comprises a laser cutting head, which is movable along a transport direction and vertically thereto. A stretching device for stretching a metal sheet is also provided. To this end, a metal sheet is held by means of two clamping devices so that a tensile stress can be exerted onto the metal sheet by means of two clamping devices. The device described there is used for the welding of metal sheets.

A method for producing a sheet-metal blank by means of laser cutting is known from EP 1 586 407 A1. There, a sheet-metal strip is fed in a transport direction to a laser cutting device, which has a laser cutting head movable back and forth in the transport direction and in a y-direction extending vertically to the transport direction. The sheet-metal strip is straightened upstream by means of a roll straightening machine. A loop pit is disposed between the roll straightening machine and the laser cutting device. In practice, a sheet-metal strip straightened by means of a roll straightening machine sometimes has a waviness. This can mean that a laser cutting head contacts the sheet-metal strip and possibly shifts the position thereof. This leads, during the cutting process, to a deviation from a predefined cutting path. Regardless of this, the cutting edges in the region of wavy surfaces are not cut perpendicularly, but instead obliquely. Lastly, when roll-straightening a metal sheet, stresses contained in said sheet are not eliminated. Consequently, cutting by means of a laser cutting device can result in a release of stresses and thus can lead to a warping or distortion of the cut-out sheet-metal blanks.

Document DE 100 42 197 A1 discloses a method and a device for producing a sheet-metal blank by means of laser cutting. The device has two clamping jaws for clamping a sheet-metal part. The device is suitable for insertion of a sheet-metal part into the device and for holding of the sheet-metal part by means of the clamping device. The clamping device is also suitable for stretching the accommodated sheet-metal part and then relaxing it. During or following the execution of the stretching process, a sheet-metal blank can be cut out from the metal sheet by means of the laser cutting device by moving the laser cutting head along a predefined cutting path.

The object of the invention is to overcome the disadvantages according to the prior art. In particular, a method and a device shall be described with which it is possible to produce sheet-metal blanks having improved flatness. In accordance with a further objective of the invention, the sheet-metal blanks shall be produced as exactly as possible in accordance with a predefined contour.

This object is achieved by the features of claims 1 and 5. Expedient embodiments of the invention shall become clear from the features of the dependent claims.

In accordance with the invention, a method is proposed for producing a sheet-metal blank by means of laser cutting, comprising the following steps:

feeding a metal sheet in a transport direction to a laser cutting device which has a laser cutting head movable back and forth in the transport direction and in a y-direction extending vertically to the transport direction,

clampingly gripping a first portion of the metal sheet upstream of the laser cutting device by means of a first clamping device and clampingly gripping a second portion of the metal sheet downstream of the laser cutting device by means of a second clamping device,

stretching the metal sheet accommodated in the laser cutting device by generating a tensile stress on the metal sheet clampingly held between the first and the second clamping device,

relaxing the metal sheet, and

cutting the sheet-metal blank from the metal sheet by moving the laser cutting head along a predefined cutting path.

The proposed method enables a rapid production of sheet-metal blanks. The sheet-metal blanks are characterised by a high contour accuracy and improved flatness. Since the metal sheet is only stretched when it is accommodated in the laser cutting device, the step of transporting the metal sheet into a stretching device and the step of further transporting the stretched metal sheet to the laser cutting device can be spared. The execution of the proposed method requires a particularly small amount of space. Regardless of this, the sheet-metal blanks cut from the sheet-metal strip are largely stress-free on account of the upstream stretching step. In particular, they are not distorted. This facilitates the further processing of the sheet-metal blanks in subsequent processing steps.

The term “stretching” is understood within the sense of the present invention to mean a cold forming by means of uniaxial and moment-free tensile loading. A tensile load is selected so that the yield point of a metal forming the metal sheet is exceeded, so that the metal sheet is plastically deformed.

The metal sheet is advantageously held at most by one of the clamping devices during the cutting. In other words, after the metal sheet has been relaxed, a clamping connection of one of the clamping devices is released. It is also possible that the clamping connections of both clamping devices are released during the cutting of the metal sheet. It is thus ensured that the metal sheet is not under tensile stress during the cutting.

In accordance with a further embodiment of the invention, the metal sheet is a sheet-metal strip, which is unwound continuously from a coil and is guided through a loop pit upstream of the first clamping device. This makes it possible advantageously to feed the metal sheet in a clocked manner to the laser cutting device. In order to further improve the flatness of the metal sheet, the sheet-metal strip can be straightened upstream of the loop pit by means of a roll straightening machine.

The metal sheet can also be constituted by sheet-metal plates which are fed to the laser cutting device in succession in a clocked manner, for example by means of a robot. Cut sheet-metal blanks can be removed likewise by means of a robot or transported away by means of a suitable conveying device.

In accordance with a further provision of the invention, a device for producing a sheet-metal blank by means of laser cutting is proposed, comprising:

a laser cutting device having a laser cutting head movable back and forth in a transport direction and in a y-direction extending vertically to the transport direction, and

a stretching device for stretching a metal sheet accommodated in the laser cutting device, comprising a first clamping device provided upstream of the laser cutting device for clampingly gripping a first portion of the metal sheet, a second clamping device provided downstream of the laser cutting device for clampingly gripping a second portion of the metal sheet, and a mechanism for changing a distance between the first and the second clamping device such that a tensile stress is exerted onto a metal sheet that is clampingly gripped therewith, in such a way that the yield point of a metal forming the metal sheet is exceeded, so that the metal sheet is plastically deformed.

The proposed device enables a quick production of sheet-metal blanks. The sheet-metal blanks are characterised by a high contour accuracy and an improved flatness. The proposed device is particularly space-saving.

In accordance with an advantageous embodiment, the stretching device comprises a frame formed of two longitudinal struts extending in the transport direction, a first stretching crossmember accommodating the first clamping device and extending in the y-direction, and a second stretching crossmember accommodating the second clamping device and extending in the y-direction. The two longitudinal struts are provided on either side of the laser cutting device. The stretching crossmembers extend over a width of the metal sheet in the y-direction as far as the longitudinal struts.

The laser cutting device is advantageously arranged within the frame in plan view. For example, a hydraulic device can be provided in the region of the longitudinal struts as a mechanism for changing the distance between the first and second clamping device, by means of which hydraulic device at least one of the two stretching crossmembers can be moved back and forth in the transport direction.

In accordance with a further embodiment the device comprises a feeding device for feeding the metal sheet to the laser cutting device in the transport direction. The feeding device can be a robot or a pair of transport rollers disposed upstream of the first clamping device.

The metal sheet is expediently a sheet-metal strip accommodated on a coil. A loop pit can be provided upstream of the feeding device. This makes it possible to unwind the metal sheet continuously from the coil. The metal sheet is expediently fed to the laser cutting device in a clocked manner by means of the feeding device.

In order to discharge the cut sheet-metal strip, a discharge device can be provided. This can be the robot or a further pair of transport rollers disposed downstream of the second clamping device.

Exemplary embodiments of the invention will be explained in greater detail hereinafter with reference to the drawings, in which:

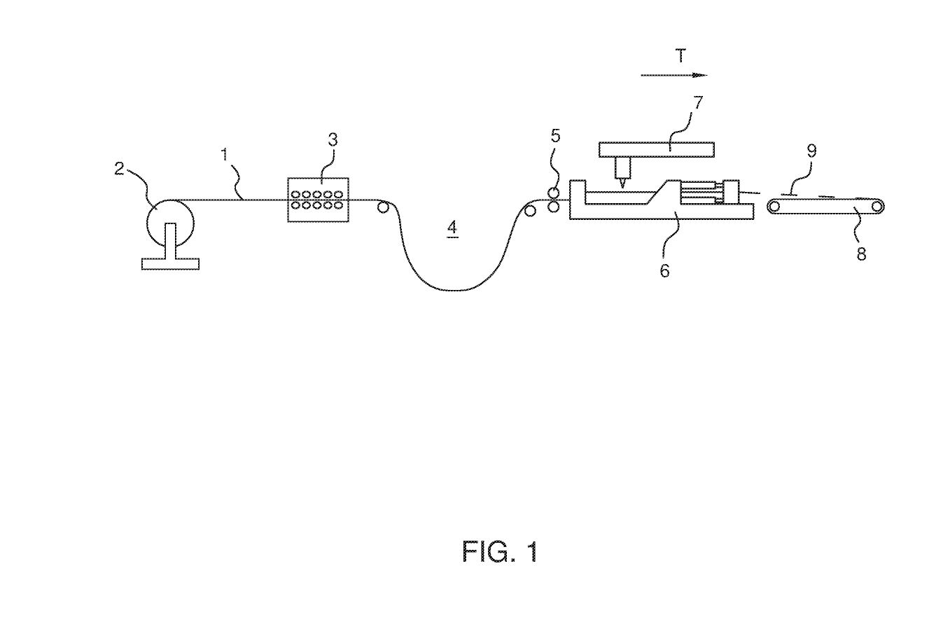

FIG. 1 shows a schematic side view of a laser cutting line,

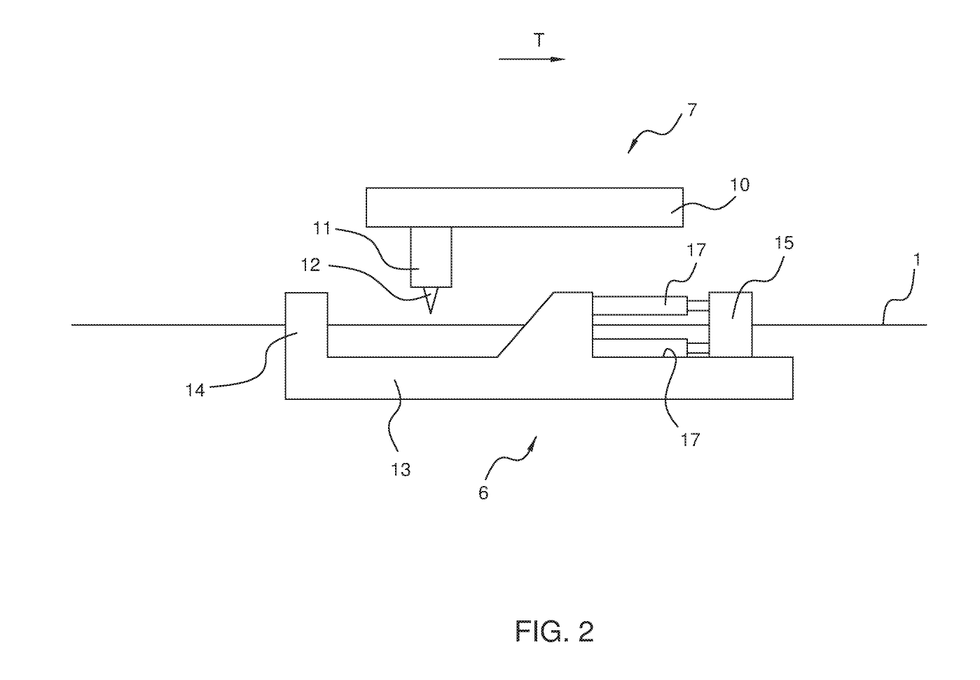

FIG. 2 shows a schematic side view of the combined stretching and laser cutting device in FIG. 1,

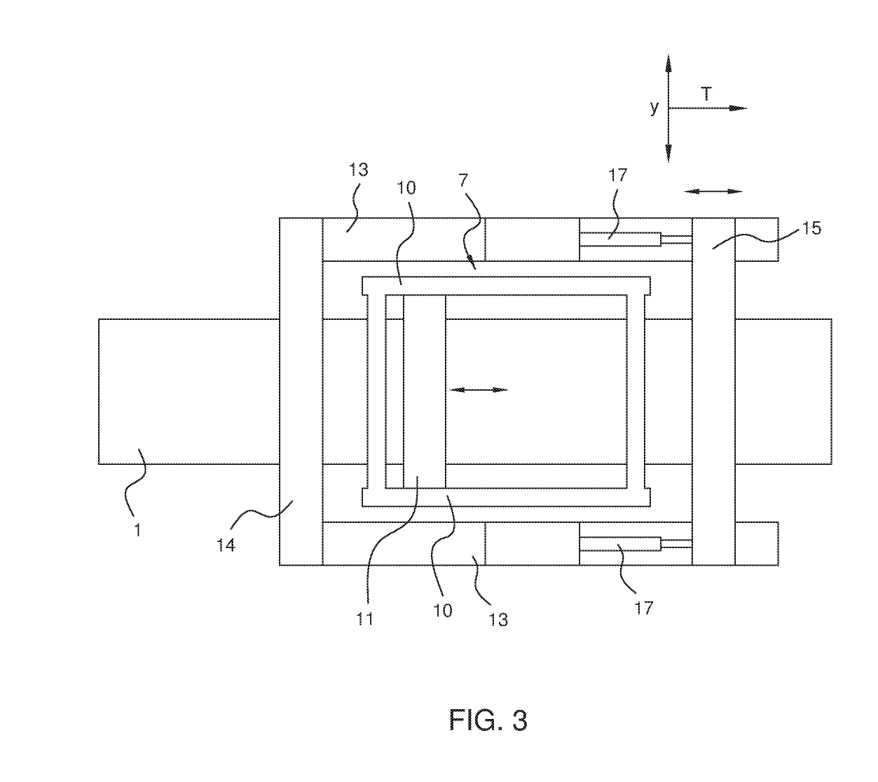

FIG. 3 shows a plan view according to FIG. 2, and

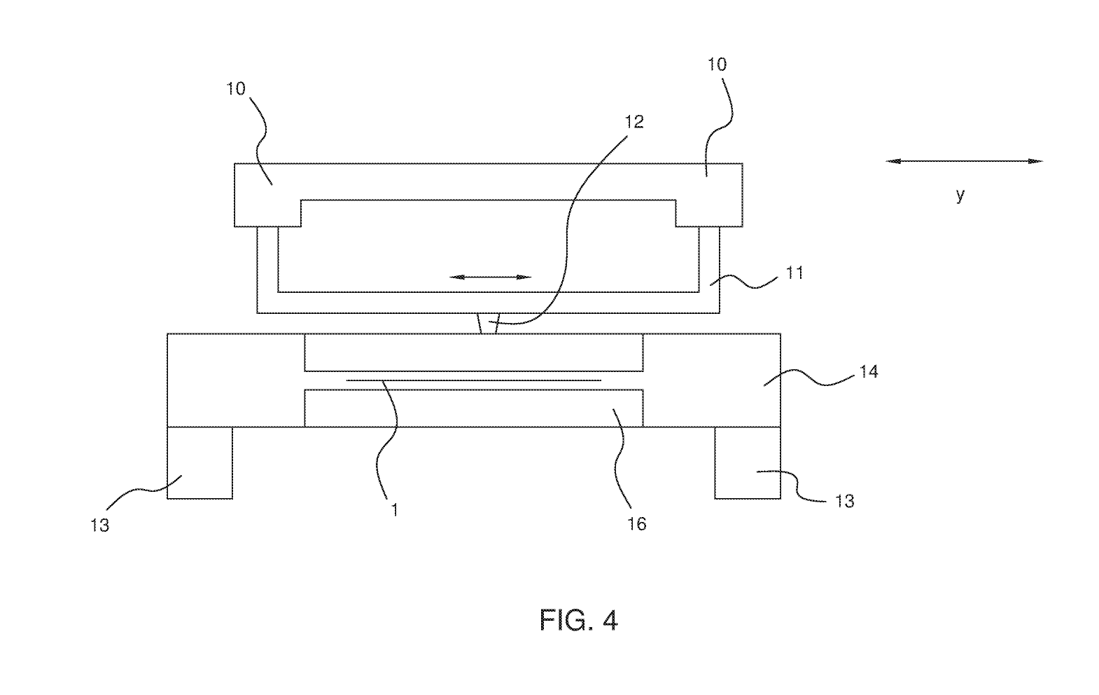

FIG. 4 shows a front view according to FIG. 2.

In the case of the laser cutting line shown in FIG. 1, a sheet-metal strip 1 is unwound from a coil 2 and is guided through a roll straightening machine 3 in a transport direction T. A loop pit 4 is disposed downstream of the roll straightening machine 3. Reference sign 5 denotes a feeding device formed for example of two mutually opposed clamping rollers for feeding the sheet-metal strip 1 to a combined stretching and laser cutting device. The stretching device is denoted by reference sign 6, and the laser cutting device is denoted by reference sign 7. A conveyor belt 8 for transporting away cut sheet-metal blanks 9 is disposed downstream of the combined stretching and laser cutting device.

FIGS. 2 to 4 show views of the combined stretching and laser cutting device according to FIG. 1.

The laser cutting device 7 comprises two rails 10 extending in the transport direction T, from which rails a bridge 11 is suspended and is movable back and forth in the transport direction T. A laser cutting head 12 is mounted on the bridge 11 so as to be movable back and forth in a y-direction extending vertically to the transport direction T. The laser cutting head 12 can be controlled arbitrarily in the y-direction and transport direction T by means of a controller. The laser cutting head is moved by means of the controller along a predefined cutting path. The predefined cutting path corresponds to a desired outer contour of the sheet-metal blank 9 to be produced.

The stretching device 6 comprises two longitudinal struts 13, which in plan view of the laser cutting device 7 extend on either side of the rails 10 in the transport direction T. Reference sign 14 denotes a first stretching crossmember, which is arranged upstream of the laser cutting device 7. Reference sign 15 denotes a second stretching crossmember, which is arranged downstream of the laser cutting device 7. A first clamping device 16 is accommodated on the first stretching crossmember 14 and comprises mutually opposed upper and lower clamping jaws. The clamping jaws can be moved relative to one another in order to clamp the sheet-metal strip 1. The clamping jaws are expediently guided so that, when stretching the clamped sheet-metal portion, a clamping force exerted onto the sheet-metal portion by means of the clamping jaws increases. At the second stretching crossmember 15 as well—similarly to the first stretching crossmember 14—there is accommodated a second clamping device having upper and lower clamping jaws (not shown here).

Reference sign 17 denotes a hydraulic device, by means of which the second stretching crossmember 15 is movable back and forth relative to the first stretching crossmember 14 in the transport direction T. Of course, it can also be that the second stretching crossmember 15 arranged downstream of the laser cutting device 7 is fixed and the first stretching crossmember 14 arranged upstream of the laser cutting device 7 is movable back and forth relative to the second stretching crossmember 15 against the transport direction. Furthermore, it is also possible that both the first stretching crossmember 14 and the second stretching crossmember 15 are movable back and forth in the transport direction.

The device functions as follows:

The sheet-metal strip 1 unwound from the coil 2 is straightened by means of the roll straightening machine 3. The loop pit 4 is used as a store for the sheet-metal strip 1 continuously unwound from the coil 2. The sheet-metal strip is fed in a clocked manner to the combined stretching and laser cutting device by means of the feeding device 5. Once a predefined sheet-metal portion has been fed to the combined stretching and laser cutting device, the sheet-metal portion is clampingly gripped upstream and downstream by means of the clamping devices 16 provided at the first stretching crossmember 14 and the second stretching crossmember 15. The second stretching crossmember 15 is then moved in the transport direction T by means of the hydraulic device 17, so that the sheet-metal portion held between the stretching crossmembers 14, 15 is stretched. The sheet-metal portion is then relaxed. The second clamping device provided at the second stretching crossmember is opened. The sheet-metal portion can also be clampingly held by means of the first clamping device 16 provided at the first stretching crossmember 14.

A sheet-metal blank 9 having a predefined contour is then cut from the stretched sheet-metal portion by means of the laser cutting device 7. As soon as the sheet-metal blank 9 has been completely cut out from the sheet-metal portion, the cut sheet-metal portion, together with the sheet-metal blank 9, is transported out from the combined stretching and laser cutting device in the transport direction T by means of a suitable conveying device (not shown here).

Although not shown in the figures, the combined stretching and laser cutting device can also be loaded with sheet-metal plates instead of the sheet-metal strip 1.

The laser cutting device 7 can also comprise a plurality of laser cutting heads 12 movable independently of one another.

1. A method for producing a sheet-metal blank (9) by means of laser cutting, comprising the following steps:
feeding a metal sheet (1) in a transport direction (T) to a laser cutting device (7), which has a laser cutting head (12) movable back and forth in the transport direction (T) and in a y-direction extending vertically to the transport direction (T),
clampingly gripping a first portion of the metal sheet (1) upstream of the laser cutting device (7) by means of a first clamping device (16) and clampingly gripping a second portion of the metal sheet (1) downstream of the laser cutting device (7) by means of a second clamping device,
stretching the metal sheet (1) accommodated in the laser cutting device (7) by generating a tensile stress on the metal sheet (1) clampingly held between the first (16) and the second clamping device,
relaxing the metal sheet (1), and
cutting the sheet-metal blank (9) from the metal sheet (1) by moving the laser cutting head (12) along a predefined cutting path.

2. The method according to claim 1, wherein the metal sheet (1) is held at most by one of the clamping devices (16) during the cutting.

3. The method according to claim 1, wherein the metal sheet (1) is fed in a clocked manner to the laser cutting device (7).

4. The method according to claim 1, wherein the metal sheet (1) is a sheet-metal strip, which is unwound continuously from a coil (2) and is guided through a loop pit (4) upstream of the first clamping device (16).

5. A device for producing a sheet-metal blank (9) by means of laser cutting, comprising:
a laser cutting device (7) having a laser cutting head (12) movable back and forth in a transport direction (T) and in a y-direction extending vertically to the transport direction (T), and
a stretching device (6) for stretching a metal sheet (1) accommodated in the laser cutting device, comprising a first clamping device (16) provided upstream of the laser cutting device (7) for clampingly gripping a first portion of the metal sheet (1), a second clamping device provided downstream of the laser cutting device (7) for clampingly gripping a second portion of the metal sheet (1), and a mechanism for changing a distance between the first (16) and the second clamping device such that a tensile stress is exerted onto a metal sheet (1) that is clampingly gripped therewith, in such a way that that the yield point of a metal forming the metal sheet (1) is exceeded, so that the metal sheet (1) is plastically deformed.

6. The device according to claim 5, wherein the stretching device (6) comprises a frame formed of two longitudinal struts (13) extending in the transport direction (T), a first stretching crossmember (14) accommodating the first clamping device (16) and extending in the y-direction, and a second stretching crossmember (15) accommodating the second clamping device and extending in the y-direction.

7. The device according to claim 6, wherein the laser cutting device (7) is arranged within the frame in plan view.

8. The device according to claim 5, further comprising a feeding device (5) for feeding the metal sheet (1) in the transport direction (T) to the laser cutting device (7).

9. The device with a metal sheet (1) according to claim 5, wherein the metal sheet (1) is a sheet-metal strip accommodated on a coil (2).

10. The device according to claim 5, wherein a loop pit (4) is provided upstream of the feeding device (5).

11. The device with a metal sheet (1) according to claim 5, wherein the metal sheet (1) can be fed in a clocked manner to the laser cutting device (7) by means of the feeding device (5).

12. The device according to claim 6, wherein the mechanism for changing the distance between the first (16) and the second clamping device is a hydraulic device (17), by means of which at least one of the two stretching crossmembers (14, 15) can be moved back and forth in the transport direction (T).
